(19) United States
(12) Patent Application Publication
(10) Pub. No.: US 2017/0341831 A1
(43) Pub. Date: Nov. 30, 2017

(54) INJECTION OF SUPPLEMENTS INTO DRINKS

(71) Applicant: Hydra Heating Industries, LLC, Atlanta, GA (US)

(72) Inventor: Michael Hoffman, Foley, AL (US)

(21) Appl. No.: 15/605,298

(22) Filed: May 25, 2017

Related U.S. Application Data
(60) Provisional application No. 62/342,436, filed on May 27, 2016.

(51) Int. Cl. B65D 51/28; B65D 25/14; A23L 2/52; B65D 85/72; B65D 25/34

(52) U.S. Cl. CPC B65D 51/2828; B65D 85/72; B65D 25/34; A23L 2/52; B65D 25/14; A23V 2002/00

(57) ABSTRACT

Aspects and embodiments injection of supplements into drinks are described. In one embodiment, a cap includes a top of the cap having a button. A container is sealed using a sealing layer between the container and the top. A pushing element is in connection with a bottom surface of the button and further in connection with a top surface of the sealing layer. A breaking mechanism is sealed within the container along with a supplement. The breaking mechanism has breaking bars that extend from a central column that is aligned with the pushing element. When the button is depressed, the breaking mechanism breaks a bottom of the container to release at least some of the supplement.

### CROSS-REFERENCE TO RELATED APPLICATIONS

This application claims the benefit of U.S. Provisional Application No. 62/342,436, filed May 27, 2016, titled “Injection of Phytosterols, Phytostanols, Polyphenols and other health supplements in Beverages and Drinks,” which is incorporated herein by reference in its entirety.

### BACKGROUND

Vitamins, nutrients, chemicals, and other supplements can be mixed with a liquid for drinking. Some supplements can benefit from mixing immediately before drinking, as they can degrade in quality, change form, or settle in the drink. This can leave the drink less effective or unappealing for consumption. Accordingly, mixing supplements into drinks immediately before drinking can be desirable or beneficial.

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1 illustrates an exploded view of an apparatus for injection of supplements into drinks, according to an embodiment of the present disclosure.

FIG. 2 illustrates views of apparatuses for injection of supplements into drinks, situated over drink containers according to embodiments of the present disclosure.

FIG. 3 illustrates a perspective view of components of an apparatus for injection of supplements into drinks, according to an embodiment of the present disclosure.

FIGS. 4A-4B illustrate perspective views of an apparatus for injection of supplements into drinks, according to an embodiment of the present disclosure.

### DETAILED DESCRIPTION

As noted above, mixing supplements immediately before drinking can be desirable. The present disclosure describes methods, systems, and apparatuses for injection of supplements into drinks. The systems and apparatuses described herein can inject or mix vitamins, nutrients, medicines, sweeteners, flavorings, chemicals, and other supplements into water, carbonated water, coffee, tea, juices, sodas, other drinks, and other liquids. Some packaging, stacking, and distribution norms can influence price points, ease of manufacture, and introduction of new products. A system or apparatus for injection of supplements into drinks according to the present disclosure can further be designed to the same or similar dimensions as existing drink containers so as to conform to packaging, stacking, and distribution norms, or to work along with existing bottles and containers. In other cases, the bottles and other containers can be uniquely formed as part of the systems and apparatuses described herein.

Micro- and/or nano-encapsulation can be utilized with the supplement to be mixed. For example, where supplements used in the methods, systems, and apparatuses can degrade in quality, effectiveness, or appeal when mixed in liquids, micro- and/or nano-encapsulation can be utilized in order to further protect against these undesirable effects. Micro- and nano-encapsulation materials can include polysaccharides, fats, waxes, bees wax, proteins, gum arabic, hydrogenated vegetable oils, gelatins (types A and B), modified starches, whey proteins, hydrolysed starches (maltodextrins), soy proteins, alginates, sodium caseinates, pectin, carrageenan, and other food grade capsule shell materials.

In some embodiments, an apparatus for injection of supplements into a liquid can include a top of a cap that includes a button. The apparatus can include a container sealed using a sealing layer between the container and the top. A pushing element can be in connection with a bottom surface of the button and further in connection with a top surface of the sealing layer. A breaking mechanism can also be sealed within the container. The breaking mechanism can include a plurality of breaking bars that extend from a central column, wherein the central column of the breaking mechanism is aligned with the pushing element. A supplement can be sealed within the container. In some cases, when the button is depressed, the breaking mechanism can break a bottom surface of the container to release at least some of the supplement into the liquid. In further cases, the supplement can include a phytosterol.

In some cases, a bottom of the container has holes corresponding to the breaking arms. The holes can be sealed using one or more sealing sheet. A material of the one or more sealing sheet can be a foil or a film, a plastic, or another material.

In some situations, the bottom of the container can include sections corresponding to the breaking arms and a framework around the sections. The sections can be thinner than the framework. The container can be coated using a hydrophobic or super-hydrophobic coating, or can be made of a hydrophobic or super-hydrophobic material.

In some cases a lever can be attached to the top of the cap that depresses the button when a first end of the lever is lifted using a second end of the lever. In further cases, a number of tabs around the button can be used to hold the button substantially flush with the top of the cap. The plurality of tabs can be broken when the button is depressed.

As discussed herein, supplements including phytosterols like ergosterol and sitosterol can be injected into drinks like water, coffee, tea, juices beer, wine and liquor. Microencapsulation can also be used with any of the supplements. Sufficient quantities of ergosterol and or sitosterol can reduce cholesterol (among other benefits). This disclosure can add quantities of supplements to drinks, including beer or other alcoholic beverages to provide a pathway for ingestion.

Authors vary concerning the estimated dietary intake of phytosterols required to show beneficial effects on serum cholesterol but the level has been estimated to be 0.8-3.0 g per day. A typical normal intake of phytosterol would be in the range 160-400 mg per day. The quantities of many such supplements can be too low to show benefits, for many diets. Accordingly, supplementation can be beneficial.

According to this disclosure, in one embodiment, Ergosterol and Sitosterol (in ethanol soluble form) can be mixed in drinks including alcoholic beverages, for example beer and wine. The added phytosterols provide health benefits. These and other types of phytosterols may be beneficial to health. In another embodiment, microencapsulated supplements like vitamins can be added to drinks as discussed, including water, coffee, tea, other nonalcoholic beverages, beer, wine, and other alcoholic beverages. The supplements can be micro- or nano-encapsulated with appropriate alginates, polymeric, or other approved capsulation materials. Small particles, not noticeable to the drinker can be utilized. In another embodiment, nano-encapsulated supplements with high bioavailability are added to the drink. In another embodiment, nano-encapsulated supplements add polyphenols like resveratrol. The supplements can be delivered using small packets. The supplements can also be delivered using supplement release caps.

Nano-encapsulated sterols or stanols work in coffee, tea, juices, sodas and nearly all beverages. For supplements, including those that do not lend themselves to direct infusion (due to a variety of factors like specific gravity, ability to withstand alcoholic environment, soda environment, or environment of water or other beverages can be held in a cap assembly made to release the supplements at the time of use. This cap can be made to be of the same exterior height as is presently used, causing as few changes in packaging, stacking and distribution as possible. Other caps that perform the same function can be made according to this disclosure.

The cap can be attached to a container using any appropriate method, including clamp on or screw on methods. The exterior of the cap can be slightly elongated to allow for an inner chamber or container that can hold supplements. The top of the cap can have a push button. The user pushes the button, breaking the seal at the bottom of the inner chamber or container. There can also be tabs around the button that are broken with the user pushes the button. The supplements, which can include micro- or nano-encapsulated and/or non-encapsulated substances drops into the liquid drink.

A small piston or other pushing element can be connected to the underneath of the top push button. The piston can be levered or leveraged to break the bottom of the container to release or inject the supplements into the drink. The inner container can be plastic. The container can also include hydrophobic or super-hydrophobic polyethylene terephthalate (PET), which can be used as the material of the container, or as a coating to the container. Another layer that can be broken by the piston and breaking mechanism with a number of breaking bars extending from a central column at various angles around the central column. The breaking bars can be knife-like projections that evenly break the container, which when the bottom is broken allows the supplements in the container to drop into the liquid via gravity. The even breaking can help to release more of the supplements into the drink than other solutions.

In one embodiment, a phytosterol such as ergosterol or sitosterol (or another or different type of phytosterol/or phytostanol is added to beer (or another type of beverage, with or without alcohol like tea, beer, or coffee) as a supplement using the release cap or during manufacture. It is added in sufficient quantities as a supplement such that the beneficial effects of the phytosterols are realized by the consumer. In another embodiment vitamin C can be microencapsulated and added as a supplement. In yet another embodiment, vitamin C is nano-encapsulated and added as a supplement. Many people need health creating supplements. The invention offers a means to deliver the healthy supplements through solubility, micro and nano encapsulation, and through a release cap to inject or release the supplements into drinks. Ergosterol and Sitosterol (in ethanol soluble form) can be mixed in beverages, for example beer, coffee, tea and wine. The added phytosterols can provide health benefits. These supplements may be in the drink or in a release cap and injected at the time of use. In another embodiment, microencapsulated supplements like vitamins are added tastelessly to the beer or other alcoholic beverage, microencapsulated or nano-encapsulated with appropriate alginates or other approved capsulation materials. Small particles, not noticeable to the drinker can be utilized. These supplements may be in the liquid or in a release cap and injected at the time of use. In another embodiment, nano-encapsulated supplements with high bioavailability are added to the beer or other alcoholic beverage. These supplements may be in the liquid or in a release cap and injected at the time of use.

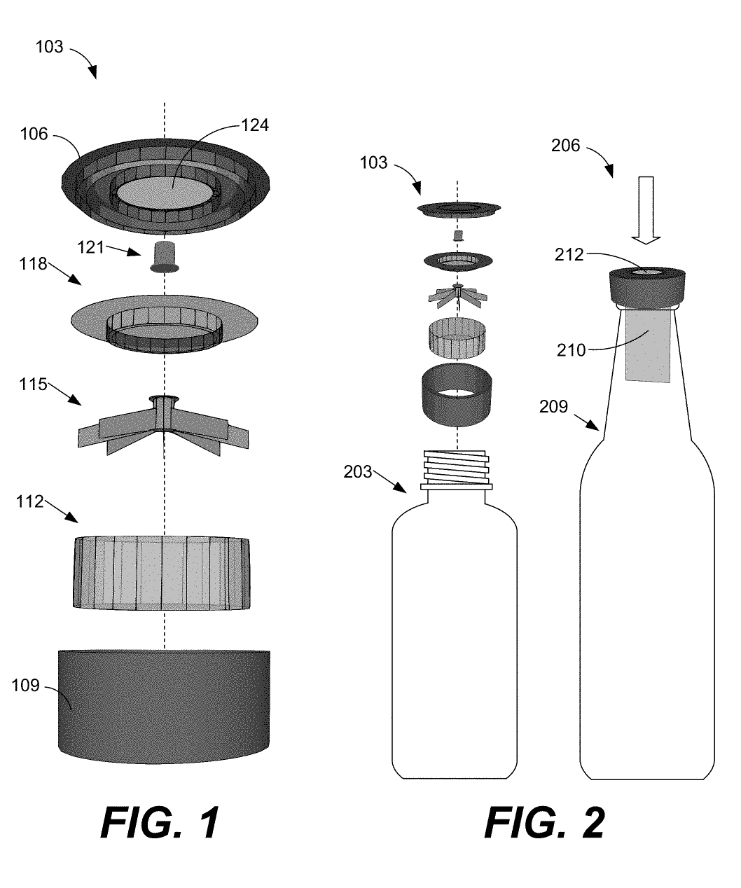

FIG. 1 illustrates an exploded view of a release cap 103 for injection of supplements into drinks, according to an embodiment of the present disclosure. The release cap 103 includes a top 106 and a body 109, a container 112, a breaking mechanism 115, a sealing layer 118, and a pushing element 121.

The body 109 can include an integrated connecting mechanism that can be used to connect the release cap 103 to a drink container such as a plastic bottle, a glass bottle, a can, or another container. For example, the body 109 can include threads that accept the threads on a top of a container, such as plastic threads of a plastic water bottle or a soda bottle, or glass threads of a glass beer bottle. Crimp-on connections for glass bottles can also be utilized. While shown in exploded form for clarity, the top 106 and the body 109 can be manufactured as a single unit or separately.

A button 124 can be substantially flush with the top 106. The button 124 can be considered part of the top 106 or separate from the top 106. The button 124 can be pushable or depressable, such that when pushed or depressed from above, such as by a user of the release cap 103, a supplement is released into a drink such as water, coffee, tea, beer, wine, soda, or other drinks. The button 124 can be connected to the top 106 using a number of breakable tabs around a periphery of the button, to hold the button 124 in place and to prevent unwanted or premature release of the supplement into the drink. In other cases, the button 124 can be separate and not attached to the top 106, and can be free-floating. In such cases, the button 124 can be held in place using a section of the button 124 that is wider in diameter than a hole in the top 106, while a top of the button 124 is approximately the size of the hole, or smaller than the hole.

A piston, plunger, or other pushing element 121 can be in connection with the button 124. While shown separately for clarity, in some cases, the pushing element 121 can be an integrated part of the button 124 as a single unit.

A sealing layer 118 can be between the top 106 and the container 112, and between the button 124 and the container 112. In some cases, the sealing layer 118 can be considered a top of the container 112. In some cases the sealing layer 118 is detachably connected to the container 112, such as by snap-in, screw-in connection, or other attachable, detachable, and re-attachable connection. In this way, the container 112 can be a replaceable container and the release cap 103 can be re-usable.

The sealing layer 118 can seal the container while providing an interface between the breaking mechanism 115 and the pushing element 121. In some cases, the sealing layer 118 can be attached to the top 106. For example, the sealing layer 118 can be attached to both the top 106 and the container 112 so that when the button 124 is depressed, the container 112 remains steady so that the button 124 applies pressure to the pushing mechanism 121 (which may be part of the button), and the pushing mechanism 121 applies pressure to the breaking element 115 through the sealing layer 118, and the bottom of the container 112 can be broken by the breaking mechanism 115.

Also, in some cases, the sealing layer 118 can be attached to the pushing element 121, and in other cases they can be separate. In some cases where the sealing layer 118 is attached to the pushing element 121, and the pushing element 121 is attached to the button 124, the button 124 can be held in place (e.g., prevented from falling out) through its attachment (through the various components) to the sealing layer 118, which can be held steady by the connection through the container 112 to the top 106. In other cases, a center area of the sealing layer 118 can be made of a foil, a film, or other thin material such as plastic, such that it is inappropriate to hold the button in place. Films can be plastic, PET, PTFE, and other materials, and can be hydrophobic, superhydrophobic or not hydrophobic. An outer area of the sealing layer 118 can be made or more substantial material for connection to the top 106, for example a pop-in connection with a solid seal, a crimp-in connection or other physical connection. Heating or melting can also be used. In some cases the center area can be lower than the outer area, in order to accommodate the pushing element 121. In some cases, the sealing layer 118 can be broken in the pushing release process, which can provide a path for gas to escape, for example in carbonated drinks. In other cases, the sealing layer 118 can be designed not to break, so that the release cap 103 can still be used as sealing cap for the drink.

The container 112 can be made of plastics, PETs, PTFEs, or other materials. In some cases, the materials can be hydrophobic, super-hydrophobic or not hydrophobic. The interior and/or exterior can also be coated with a hydrophobic, super-hydrophobic or not hydrophobic coating. For example, to protect the drink, protect the supplements, and any components from degradation. In some cases, the material can be impermeable to liquids but permeable by gasses, thereby allowing pressure to equalize within the container 112 with the drink container, where the contents are pressurized. This can prevent the container 112 from collapsing or breaking.

The breaking element 115 can be sealed within the container 112. Accordingly, the breaking element 115 can be separate from the other components of the release cap 103. The breaking element 115 can include a number of breaking bars to break a bottom of the container 112 when the button is depressed. The breaking bars can be situated around and extend from a central pillar or column of the breaking element 115. In some cases the breaking bars can be blade-like in order to break or cut the bottom of the container. In other situations, the breaking bars can be relatively blunt, but nevertheless designed to break the bottom of the container 112 in a number of places to release the supplement from the container 112 into the drink. In some cases the breaking element 115 be made of or coated with a hydrophobic or super-hydrophobic material like PET, Polytetrafluoroethylene (PTFE). The breaking element 115 is sealed within the container 112, along with the supplements, so it can be made of material that will not foul or spoil or degrade the supplements, and that the supplements will not foul or spoil or degrade the breaking element 115.

While each breaking bar is shown as a blade that extends at an angle downward, the breaking bars can extend straight outward. Also, while not shown, each breaking bar can have one or more a protrusion, such as a cylindrical protrusion (circular/ovular cross-section) or a rectangular protrusion (rectangular cross-section), cross-shaped protrusion (cross-shaped cross-section), extending from a bottom of each breaking bar. The protrusions can be pointed at a bottom tip, or can be uniform extrusions extending from the bottom of each breaking bar. A protrusion can also extend downward from the central column. The protrusions can be designed to break the bottom of the container 112 in various locations, for example at a corresponding foil, film, or thin section of the container 112. Further, each blade can be curved or scimitar or crescent shaped, for example, a bottom of the blade or breaking bar can be curved or scimitar or crescent shaped. Blades can be made of metals, plastics, stainless steels, or any appropriate material.

The height of the breaking mechanism 115 can be similar to a height of the interior of the container 112, so that the breaking mechanism 115, which can be sealed inside, does not move or become dislodged or out of place within the container 112. Additional components of the breaking mechanism 115, including the blades, bars, or other elements (shown or not shown) can be designed to hold the breaking mechanism in place and prevent dislodging.

While the container 112 is shown smaller than the body 109, the container 112 can also extend any length downward, for example, into a drink container well below the rest of the cap. In some cases, the central column of the breaking mechanism can be designed such that the height of the breaking mechanism 115 can be similar to a height of the interior of the container 112.

It should be noted that the container 112 can also have a tube-like projection that extends from its periphery down below its bottom surface, so that the blades are not exposed below the tube-like projection. In other cases, the container 112 can have a catch-tray below the container 112 and attached to the periphery about the container 112, the catch-tray having a frame-like formation. Such a frame can prevent the blades or breaking bars from falling into the drink, and can also prevent the blades or bars from being touched when the release cap is removed, such as where the blades are particularly sharp or would otherwise be unsafe to touch. A frame as described can be useful where an entire bottom of the container 112 is a foil or film that may be incapable of holding the breaking mechanism 115 when the bottom is broken. In some cases, the blades are designed to break the bottom of the container while being blunt enough to be safe to the touch.

FIG. 2 illustrates views of apparatuses for injection of supplements into drinks, situated over drink containers according to embodiments of the present disclosure. The release cap 103 is shown in exploded view over a drink container 203, which has a threaded top. The drink container 203 can be a typical water bottle or soda bottle, or can be a uniquely designed container specifically designed for use with the release cap 103. In some cases where the container is a typical or existing style of bottle such as a typical water bottle or soda bottle, the release cap 103 can be designed such that a total height of the release cap 103 and the drink container 203 is similar to a total height of the typical or existing style of bottle and its corresponding cap for packaging, shipping, and manufacture.

Also in FIG. 2, the release cap 206 is shown attached to the container 209. The release cap 206 can have a crimp-on connection element or a screw-on element that is appropriate for the drink container 209, which can be a glass bottle. As shown, the container 210 of the release cap 206 can extend well into the drink container 209 in some situations, and in some cases, even into a liquid within the drink container 209. The button 212 can be pressed in the direction shown in order to break the container 210 and release or inject a supplement into the liquid within the drink container.

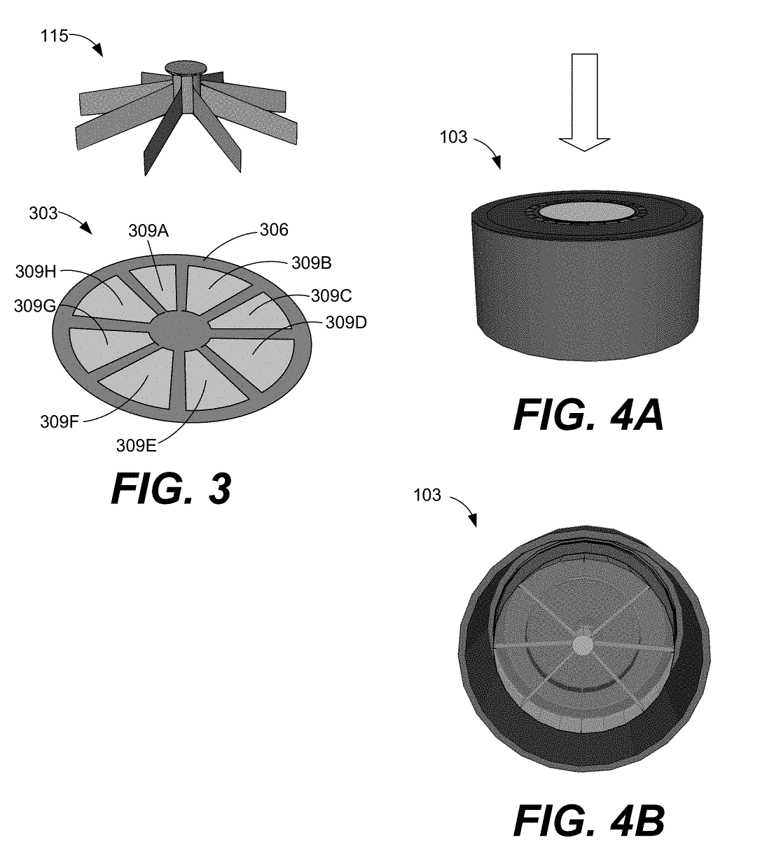

FIG. 3 illustrates a perspective view of components of an apparatus for injection of supplements into drinks, according to an embodiment of the present disclosure. A breaking mechanism 115 is shown for reference above a representation of a bottom 303 for a supplement container such as the container 112 (FIG. 1). The bottom 303 of the supplement container includes a number of thin sections or thin areas 309A-H (collectively thin areas 309) and a frame 306. The thin areas 309A-H each can correspond to a breaking bar or blade of the breaking mechanism 115. These components can allow the thin areas 309 to be broken by the breaking mechanism 115 while preventing it from falling into the drink. The frame 106 can be designed to prevent the breaking mechanism 115 from falling into the drink, or in other words can be designed to contain the breaking mechanism 115 once one or all of the thin area(s) 309 are broken. In some cases the thin areas are the same material as the supplement container and are part of a single unit, for example molded extruded or otherwise manufactured along with the frame 306 to be thinner than the frame 306. In other situations, they are different materials. For example, the frame can be a first material such as a plastic, and the thin areas 309 can be a single foil or film across the bottom of the supplement container to seal it. In some cases, each of the thin areas can be a separate film or foil and they can collectively seal the bottom of the supplement container.

FIGS. 4A-4B illustrate perspective views of the release cap 103 for injection of supplements into drinks, according to an embodiment of the present disclosure. These figures are provided to show the assembled product for clarity. FIG. 4A shows the button that can be depressed in order to inject or release the supplements. FIG. 4B shows the bottom view of the release cap 103. The container can be seen, and is shown translucent with the breaking element sealed within.

As used herein, the term “approximate,” or “approximately” can refer to a distance or measure that differs by about 30% or less, about 25% or less, about 20% or less, about 15% or less, about 10% or less, or about 5% or less than the indicated distance or measure. The term “or less” can indicate a range that extends to 0% or to 0.01%. As used herein, the term “similar to,” for example in the phrase “diameter similar to,” can refer to diameter that differs by about 30% or less, about 25% or less, about 20% or less, about 15% or less, about 10% or less, or about 5% or less. The term “or less” can indicate a range that extends to 0% or to 0.01%.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. A system for injection of supplements into a liquid, comprising:
a first container;
a liquid within the first container;
a cap detachably attached to the first container using an integrated connector of the cap, the cap comprising a pushable button;
a second container sealed using a sealing layer between the second container and a bottom of the cap;
a pushing element in connection with a bottom surface of the pushable button and further in connection with a top surface of the sealing layer;
a breaking mechanism sealed within the second container, the breaking mechanism comprising a plurality of breaking bars that extend from a central column, wherein the central column of the breaking mechanism is aligned with the pushing element;
a supplement sealed within the second container; and
wherein when the pushable button is depressed, the breaking mechanism breaks a bottom of the second container in a plurality of locations to release at least some of the supplement into the liquid within the first container.

2. The system of claim 1, wherein the supplement comprises at least one phytosterol.

3. The system of claim 1, wherein the bottom of the second container comprises a plurality of holes corresponding to the plurality of breaking arms, the holes being sealed using at least one sealing sheet.

4. The system of claim 3, wherein a material of the at least one sealing sheet is a foil or a film.

5. The system of claim 1, wherein the bottom of the second container comprises a plurality of sections corresponding to the plurality of breaking arms, and a framework around the plurality of sections, the plurality of sections being thinner than the framework.

6. The system of claim 5, wherein the framework and the plurality of sections are made of a same material.

7. The system of claim 6, wherein the material of the framework and the plurality of sections is hydrophobic polyethylene terephthalate (PET) or super-hydrophobic PET.

8. The system of claim 1, wherein the second container is coated using a super-hydrophobic coating.

9. A cap for injection of supplements into a liquid, comprising:
a top of the cap comprising a button;
a container sealed using a sealing layer between the container and the top;
a pushing element in connection with a bottom surface of the button and further in connection with a top surface of the sealing layer;
a breaking mechanism sealed within the container, the breaking mechanism comprising a plurality of breaking bars that extend from a central column, wherein the central column of the breaking mechanism is aligned with the pushing element;
a supplement sealed within the container; and
wherein when the button is depressed, the breaking mechanism breaks a bottom of the container in a plurality of locations to release at least some of the supplement into the liquid.

10. The cap of claim 9, wherein the supplement comprises a nano-encapsulated phytosterol.

11. The cap of claim 9, wherein the bottom of the container comprises a plurality of holes corresponding to the plurality of breaking arms, the plurality of holes being sealed using at least one sealing sheet.

12. The cap of claim 11, wherein a material of the at least one sealing sheet is a foil or a film.

13. The cap of claim 9, wherein the bottom of the container comprises a plurality of sections corresponding to the plurality of breaking arms, and a framework around the plurality of sections, the plurality of sections being thinner than the framework.

14. The cap of claim 9, wherein the container is coated using a super-hydrophobic coating.

15. The cap of claim 9, further comprising a lever attached to the top of the cap, wherein when a first end of the lever is lifted a second end of the lever depresses the button.

16. The cap of claim 9, further comprising a plurality of tabs that hold the button substantially flush with the top of the cap, wherein the plurality of tabs are broken when the button is depressed.
